(19) United States
(12) Patent Application Publication
(10) Pub. No.: US 2006/0096424 A1
(43) Pub. Date: May 11, 2006

(54) Cutting blade edge application method and apparatus

(76) Inventor: Charles Klyzek, Garrison, ND (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 10/982,702

(22) Filed: Nov. 5, 2004

(51) Int. Cl. B26D 1/00; B26F 1/24

(52) U.S. Cl. 83/13; 83/30; 83/669; 83/690

(57) ABSTRACT

A method and apparatus applying a cutting edge to a cutting blade are provided that may allow the cutting edge to be created using a shearing process such that a majority of the edge is sheared without excessive breakout.

### FIELD OF THE INVENTION

Embodiments of the present invention relate to cutting blades used with cutting devices, and more particularly to a method and apparatus for applying a cutting edge to a cutting blade.

### BACKGROUND

Cutting blades, such as rotary cutting blades used on lawn mowers, typically have one or more cutting edges that are disposed on a leading edge of the blade to facilitate cutting of material, such as vegetation. The cutting edge may be applied to the blade in a variety of ways, including, but not limited to, milling, grinding, coining, and shearing.

The most common way a cutting edge is applied on a new blade is through the use of a milling machine with one or more milling heads. Milling machines, however, have a number of disadvantages. For example, milling machines require that the blade blank be removed from a press, where most blade processing operations take place, and be placed into a separate milling machine to create the cutting edge. Once the edge is machined, the blade is then placed back into a press for further processing, such as blade forming. This activity not only interrupts the manufacturing process, but can also be time-consuming and expensive. In particular, the mill head inserts used to machine the cutting edge can be expensive and have generally high wear rates, such that replacement can be frequent depending on the hardness of the material being milled.

Coining generally includes the use of a closed set of dies to confine and squeeze the blade material to produce a cutting edge. Coining requires that the material be repeatedly worked and generally does not sufficiently result in a satisfactory cutting edge, especially for lawn mower and other vegetation cutting blades.

A shearing process has also been used to apply a cutting edge to the cutting blade. The shearing processes used, however, have generally failed, particularly with respect to rotary cutting blades, because they do not generate an acceptable cutting edge. The cutting edge quality in prior shearing processes has been deficient for a variety of reasons. One reason, for example, is that despite some sheared surface being generated, a significant amount of breakout would occur between the cutting edge side and the material being removed. Breakout, or blowout, is generally similar to a tearing or ripping of the material, which results in a rough surface. The rough surface on the face of a cutting edge is not conducive to a satisfactory cutting edge. A second and related reason is that the clearance between the die and punch used for shearing typically ranges between 6% and 14% of the cutting blade material thickness, which has been thought to be necessary to ensure tool longevity and performance. Accordingly a substantial amount of breakout may be generated towards the front edge of the cutting edge due to the tool tolerances.

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIGS. 1A and 1B illustrate a front view and a cross-sectional view, respectively, of a skiving device in accordance with an embodiment of the present invention;

FIGS. 2A and 2B illustrate a front view and a cross-sectional view, respectively, of a skiving device in accordance with an embodiment of the present invention;

FIG. 3 illustrates an enlarged cross-sectional view of a skiving device in accordance with an embodiment of the present invention; and

FIG. 4 illustrates a perspective view of a rotary cutting blade in accordance with an embodiment of the present invention.

### DETAILED DESCRIPTIONS OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

The following description may include terms such as inner, outer, under, between, upward, downward, outward, inward, and the like. Such terms are used for descriptive purposes only and are not to be construed as limiting. That is, these terms are terms that are relative only to a point of reference and are not meant to be interpreted as limitations but are, instead, included in the following description to facilitate understanding of the various aspects of the invention.

Embodiments of the present invention may be directed to a method of applying a cutting edge to a rotary cutting blade using an improved shearing process, also sometimes referred to herein as skiving, where the amount of breakout is kept to a minimum, and the majority of the face of a cutting edge is sheared such that it is generally smooth. Skiving the blade in accordance with embodiments of the present invention may be done within a press similar to other blade processes, which may help maintain the continuity of processing, reduce the amount of times a blade must be handled, and reduce manufacturing and production costs, without sacrificing the quality of the cutting edge.

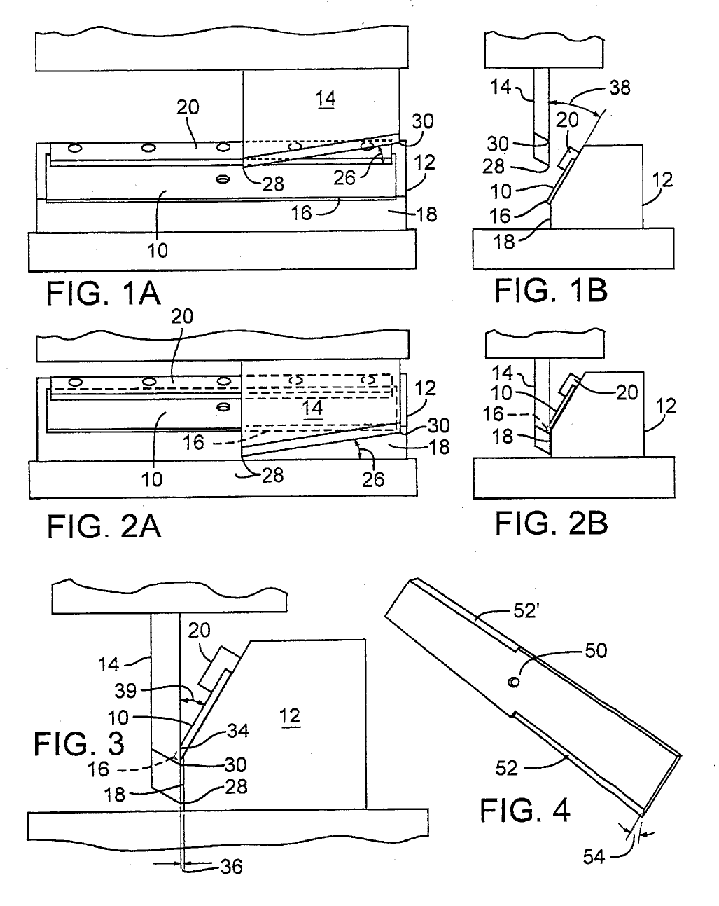

FIGS. 1A and 1B illustrate a front view and a cross-sectional view, respectively, of a skiving device in accordance with an embodiment of the present invention. A blade blank 10 may be positioned in a die 12 such that a portion of the leading edge of the blade blank 10 may overhang front edge 18 of die 12, herein referred to as the overhang portion 16. In one embodiment, a retainer 20 may be coupled to die 12 and configured to retain blade blank 10 in position for skiving.

Punch 14 may be positioned and configured to move relative to the blade blank 10 and die 12. Punch 14 may have a cutting end or working end that has a relief angle, which may be configured to urge material being skived away (i.e. the overhang portion 16) from the cutting edge being applied to blade blank 10. Punch 14 may also include a shear angle 26, such that a first edge 28 may contact a portion of blade blank 10 before a second edge 30 contacts blade blank 10.

FIGS. 2A and 2B illustrate a cross sectional view and a front view, respectively, of a skiving device in a closed position in accordance with an embodiment of the present invention. In one embodiment of the invention, as punch 14 moves relative to die 12 and blade blank 10, the first edge 28 contacts overhang portion 16 of the blade blank 10 and begins to shear the overhanging portion 16 away from blade blank 10 to form a cutting edge 34 (shown in FIG. 3). Due to the shear angle 26, as the punch 14 continues to move towards the closed position, the punch 14 progressively shears the overhang portion 16 in a direction toward the second edge 30. In one embodiment of the invention, this angular cutting action helps to establish the unique and advantageous cutting action.

The shear angle 26 may be selected based on a variety of factors, including, but not limited to, blade material, blade hardness, desired width of the cutting edge, and the like. In one embodiment, the shear angle 26 may be in the range of 8 to 30 degrees. In one embodiment, it was found that a shear angle of approximately 12 degrees may help in producing a quality skived cutting edge with a low amount of breakout. Likewise, the relief angle may be selected based on similar factors and be job specific. In one embodiment, it was found that a punch having a relief angle of approximately 16 degrees assisted in producing a satisfactory cutting edge with having a cutting edge composed primarily of a sheared surface.

FIG. 3 illustrates an enlarged cross-sectional view of a skiving apparatus in accordance with an embodiment of the present invention. In order to get as much of the face of cutting edge 34 to shear, as opposed to breakout, the clearance 36 between the punch 14 and the die 12 is kept lower than traditional clearances. Accordingly, as the punch 14 makes its pass, thereby separating the overhang portion 16 of blade blank 10 to create cutting edge 34 having a cutting edge angle 39, clearance 36 (slightly exaggerated for illustrative purposes), yields a quality cutting edge by helping to reduce the amount of breakout and increase the percentage of the cutting edge surface that is sheared. It is believed that one of the factors that may contribute to the ability to maintain such low clearances, and hence increase the amount of sheared surface, is the shear angle 26 of the punch.

In one embodiment, the clearance 36 is kept at or below 2% of the thickness of the material being skived. In embodiments where the blade blanks have a thickness in a range of 0.12 inches and 0.312 inches, a clearance of approximately 0.5% or less of the blade blank thickness has been found to result in a cutting edge that is primarily a sheared surface, with a relatively small percentage of breakout, and hence produced quality cutting edge. In one embodiment, where the blade blank is approximately 0.2 inches, a clearance of approximately 0.001 inches has been found to help minimize breakout. In one embodiment, the low clearance in combination with the shear angle enables formation of a cutting edge that is dominated by a sheared surface, and helps resist breakout from being evident on the blade's surface.

FIG. 4 illustrates a perspective view of a rotary cutting blade in accordance with an embodiment of the present invention. Blade 50 has two cutting edges 52 and 52′. Cutting edges 52 and 52′ may be formed by skiving the edge in accordance with embodiments of the present invention. Skiving in accordance with embodiments of the present invention may result in a cutting edge angle 54, which as illustrated may be approximately 30 degrees.

In one embodiment of the invention, the punch may be positioned relative to the die at an angle in the range of 25 to 40 degrees, such that the resulting cutting edge has a cutting edge angle, with respect to the bottom portion of the cutting blade, which is at substantially the same angle as the relative angle between the punch and the blade blank supporting surface of the die 12 (shown as 38 in FIG. 1B). In such a case, where the punch 14 travels vertically, the blade blank support surface of the die 12 may be configured to create an angle of 60 degrees with respect to horizontal.

Although in the illustrated embodiment the punch is shown to travel in the vertical direction, in other embodiments, the punch may travel along a path other than vertical, while the die is configured to have an increased or decreased angle with respect to horizontal in order to maintain the desired angular relationship between the punch and die to maintain the resulting cutting edge angle.

In another embodiment of the invention, the first end of the punch may be oriented toward the outer edge of the blade blank, such that the shearing action occurs from the outer portion of the blade blank towards the inner portion of the blade blank. And, in other embodiments, the punch may have a width less than the desired width of the cutting edge being created. In such embodiments, the punch and/or the die may be adapted to move, for example, horizontally, as well as vertically with respect to each other in order to achieve the elongated cutting edge. Yet, in other embodiments of the invention, the first end and the second end of the punch may be co-planar. In such a case, the shear angle may be created by orienting the die at an angle with respect to the cutting edge of the punch, in order to help induce the shearing action of the material.

Embodiments of the present invention may be particularly useful in applying a cutting edge to a rotary cutting blade blank that is made of boron steel in the range of 10B30 to 10B40. In some embodiments, the die, or the cutting portion of the die may be made of a material that is harder than the material of the blade blank itself. In other embodiments, the punch or the cutting portion of the punch may be made of a material that is treated to have a higher hardness than that of the material being sheared.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. An apparatus for applying a cutting edge to a cutting blade, comprising:
a die adapted to retain a blade blank in a stationary position; and
a punch adapted to shear material from the blade blank to form a cutting edge having an angle from horizontal in the range of 25 to 40 degrees, the punch further having a working end with a shear angle and a relief angle, and configured to have a minimum clearance from the die in a amount of less than or equal to 2% of the blade blank thickness.

2. The apparatus of claim 1, wherein the shear angle is in the range of 8 degrees to 30 degrees.

3. The apparatus of claim 2, wherein the shear angle is approximately 12 degrees.

4. The apparatus of claim 3, wherein the relief angle is approximately 16 degrees.

5. The apparatus of claim 1, wherein the die retains the blade blank at an angle of approximately 60 degrees with respect to horizontal and the punch travels vertically such that a cutting edge angle of approximately 30 degrees is applied to the blade blank.

6. The apparatus of claim 1, wherein the clearance is approximately 0.5% of the blade blank thickness.

7. The apparatus of claim 1, wherein the clearance is approximately between 0.001 inches and 0.002 inches, and the blade blank thickness is approximately 0.2 inches.

8. The apparatus of claim 1, wherein the shear angle is formed by having a punch where the working end has no angle and orienting the blade blank and die at an angle relative to the punch working end.

9. The apparatus of claim 1, wherein the shear angle is adapted to shear material from the blade blank from an interior portion of the blade blank to an outside edge of the blade blank.

10. An apparatus for applying a cutting edge to a rotary cutting blade, comprising:
a die adapted to retain a blade blank in a stationary position at an angle of 60 degrees with respect to horizontal; and
a punch adapted to move substantially vertically and shear material from the blade blank to form a cutting edge having a cutting edge angle of approximately 30 degrees, the punch further having a working end with a shear angle of approximately 12 degrees and a relief angle of approximately 16 degrees, and wherein the punch and die are configured to have a minimum clearance from each other in the range of approximately 0.001 inches to 0.002 inches.

11. A method of applying a cutting edge to a cutting blade, comprising:
providing a die configured to retain a blade blank;
positioning the blade blank in the die;
providing a punch having a shear angle and a relief angle, the punch adapted to move relative to the die and shear material from the blade blank;
orienting the punch and die such that there is an angle between the punch and blade blank in the range of approximately 25 to 40 degrees and a minimum clearance of less than or equal to 2% of the thickness of the blade blank; and
shearing material from a leading edge of the blade blank by moving the punch in at least a first direction until a cutting edge has been applied to a desired portion of the blade blank.

12. The method of claim 11, wherein the shear angle is in the range of 8 degrees to 30 degrees.

13. The method of claim 12, wherein the shear angle is approximately 12 degrees.

14. The apparatus of claim 13, wherein the relief angle is approximately 16 degrees.

15. The method of claim 11, wherein the punch has a width that is less than the width of the cutting edge, and shearing material from the leading edge includes moving the punch in the first direction and a second direction.

16. The method of claim 15, wherein the first direction is vertical and the second direction is horizontal.

17. The method of claim 11, wherein shearing material from the leading edge includes beginning to shear the material from an interior portion of the blade blank towards an outside edge of the blade blank.

18. The method of claim 11, wherein the minimum clearance is approximately between 0.001 inches and 0.002 inches.

19. A rotary mower, comprising:
a power source; and
a rotary cutting blade operationally coupled to the power source, the rotary cutting blade having a cutting edge applied by a process comprising
providing a die configured to retain a rotary cutting blade,
positioning the rotary cutting blade in the die,
providing a punch having a shear angle and a relief angle, the punch adapted to move relative to the die and shear material from the rotary cutting blade,
orienting the punch and die such that a cutting edge angle in the range of approximately 25 to 40 degrees is applied to the rotary cutting blade, and a minimum clearance of less than or equal to 2% of the thickness of the rotary cutting blade is maintained between the punch and die, and
shearing material from a leading edge of the rotary cutting blade by moving the punch in at least a first direction until the cutting edge has been applied to a desired portion of the rotary cutting blade.

20. The rotary mower of claim 19, wherein the shear angle is in the range of 8 degrees to 30 degrees.

21. The rotary mower of claim 19, wherein the shear angle is approximately 12 degrees.

22. The rotary mower of claim 19, wherein the relief angle is approximately 16 degrees.

23. The rotary mower of claim 19, wherein the clearance is approximately 0.5% of the blade blank thickness.

24. The rotary mower of claim 19, wherein the clearance is approximately between 0.001 inches and 0.002 inches, and the blade blank thickness is approximately 0.2 inches.

25. The rotary mower of claim 19, wherein the cutting edge angle is approximately 30 degrees.
